(19) United States
(12) Patent Application Publication
(10) Pub. No.: US 2012/0053816 A1
(43) Pub. Date: Mar. 1, 2012

(54) METHOD FOR DETERMINING THE OXYGEN STORAGE CAPACITY OF A CATALYTIC CONVERTER AND METHOD FOR DETERMINING A TIME DELAY INHERENT IN A LAMBDA PROBE

(75) Inventor: BODO ODENDALL, Lenting (DE)

(73) Assignee: Audi AG, Ingolstadt (DE)

(21) Appl. No.: 13/210,612

(22) Filed: Aug. 16, 2011

(30) Foreign Application Priority Data
Aug. 25, 2010 (DE) 10 2010 035 365.5

(51) Int. Cl. F02D 28/00; G01M 15/10; F01N 11/00

(52) U.S. Cl. 701/102; 73/114.75

(57) ABSTRACT

In an arrangement, wherein a post-catalytic converter lambda probe is arranged downstream of a catalytic converter having an oxygen store, and wherein both the oxygen store and the post-catalytic converter lambda probe can be subject to aging, a time delay in the reaction of the post-catalytic converter lambda probe with an aged oxygen store to the air-fuel ratio is measured when the associated internal combustion engine operates in an overrun mode. This time delay can be used to determine the oxygen storage capacity. If the oxygen store has not yet aged, a coarse estimate of the time delay is sufficient. The coarsely determined time delay is hereby used to define a coarse limit value in conjunction with a time integral or time duration.

### CROSS-REFERENCES TO RELATED APPLICATIONS

This application claims the priority of German Patent Application, Serial No. 10 2010 035 365.5, filed Aug. 25, 2010, pursuant to 35 U.S.C. 119(a)-(d), the content of which is incorporated herein by reference in its entirety as if fully set forth herein.

### BACKGROUND OF THE INVENTION

The present invention relates to a method for determining the oxygen storage capacity of an oxygen store associated with a catalytic converter in the exhaust gas system for an internal combustion engine, wherein a lambda probe is arranged downstream of at least one section of the catalytic converter in the flow direction of the exhaust gas.

The following discussion of related art is provided to assist the reader in understanding the advantages of the invention, and is not to be construed as an admission that this related art is prior art to this invention.

This method is intended operate particularly well when the oxygen store has already aged and only a fraction of its original oxygen storage capacity remains. In this context, the invention also relates to a method for determining a time delay in the response to changes of the air-fuel ratio to be measured of a lambda probe arranged downstream of at least one section of a catalytic converter with an oxygen store in the exhaust gas system of an internal combustion engine. The time delay plays a role when determining the oxygen storage capacity.

It is known to determine the oxygen storage capacity by initially removing as much oxygen as possible from the oxygen store and thereafter changing over to an exposure of the oxygen store to lean exhaust gas, thereby intentionally filling the oxygen store with oxygen. Starting at the changeover, a time integral over the quantity of oxygen introduced per unit time into the oxygen store is computed, wherein the computation is terminated, like the exposure, exactly when the output signal of the lambda probe crosses a predetermined threshold, e.g., 0.45 V.

This method produces excellent results as long as the lambda probe is fully functional. However, not only the oxygen store, but also the post-catalytic converter lambda probe, can be subject to aging. Aging of the lambda probe may particularly cause the lambda probe to respond to environmental conditions with a delay, i.e., a predetermined output signal may be observed too late. For example, the predetermined threshold is crossed with a time delay, i.e., the time integral is computed over a time which is too long.

Disadvantageously, the delay in the reaction of the lambda probe to changes in the measured air-fuel ratio must be measured precisely in order to adequately correct the integral even for a lower oxygen storage capacity, but that such a precise measurement has not been available to date.

It would therefore be desirable and advantageous to obviate prior art shortcomings and to provide an improved method for precisely measuring the oxygen storage capacity, even as the oxygen store has aged, by exactly taking a time delay into account.

### SUMMARY OF THE INVENTION

According to one aspect of the present invention, a method for determining a time delay in the reaction of a lambda probe to changes in the air-fuel ratio to be measured, wherein the lambda probe is arranged in the exhaust gas system of an internal combustion engine downstream of at least a section of a catalytic converter having an oxygen store, includes the steps of awaiting or effecting a beginning of an overrun mode of the internal combustion engine, measuring a first time duration from the beginning of the overrun mode to a time when an output signal of the lambda probe crosses a threshold value, defining a first estimated value for a second time duration from the start time until the oxygen store is filled with oxygen in overrun mode, defining a second estimated value for a third time duration from the start time until the exhaust gas reaches the lambda probe, i.e. the time duration during which the exhaust gas travels from the inlet of the catalytic converter to the lambda probe, and subtracting the first and second estimated values from the measured first time duration to produce a value for the time delay.

The method according to the invention for determining the time delay includes awaiting or effecting the occurrence of an overrun mode of the internal combustion engine. No fuel is supplied to the internal combustion engine in overrun mode, while the internal combustion engine still continues to run; a motor vehicle then coasts and the crankshaft continues to rotate. The time from the start of the overrun mode until a time when the output signal of the lambda probe crosses a limit value, in particular falls below the limit value, is then measured.

Additionally, a first estimated value for the time duration is defined during which the oxygen store is filled in overrun mode of the internal combustion engine; a second estimated value for the time duration is then defined during which exhaust gas travels from the inlet of the catalytic converter to the lambda probe; and lastly the two estimated values are subtracted from the measured time, thereby providing a value for the time delay.

The invention is based on the observation that an estimated value for the time duration, during which the oxygen store is filled in overrun mode of the internal combustion engine, can in most situations be determined with sufficient accuracy—e.g. based also on a previous measurement of the total oxygen storage capacity—, and that because the second estimated value can also be precisely determined, the time delay can also be determined with sufficient accuracy.

According to an advantageous feature of the present invention, the method may be performed in relation to a catalytic converter which was subjected to an aging process and has remaining only between about a twentieth and a fifth of its original oxygen storage capacity. In this case, the first estimated value for the time duration during which the oxygen store is filled in overrun mode of the internal combustion engine is relatively small in relation to the determined time delay.

According to an advantageous feature of the present invention, the first estimated value may be set to zero, because the time duration during which the oxygen store is filled in overrun mode of the internal combustion engine is negligible.

The time delay must be measured with the greatest possible precision especially for a small oxygen storage capacity, so that the method according to the invention operates particularly well when the oxygen store has aged.

According to another aspect of the present invention, a method for determining the oxygen storage capacity of an oxygen store associated with a catalytic converter in the exhaust gas system of an internal combustion engine, wherein a lambda probe is arranged downstream of at least a section of the catalytic converter in the flow direction of the exhaust gas, includes the steps of measuring a time delay inherent in the lambda probe by awaiting or effecting a beginning of an overrun mode of the internal combustion engine, measuring a first time duration from the beginning of the overrun mode to a time when an output signal of the lambda probe crosses a threshold value, defining a first estimated value for a second time duration from the start time until the oxygen store is filled with oxygen in overrun mode, defining a second estimated value for a third time duration from the start time until the exhaust gas reaches the lambda probe, and subtracting the first and second estimated values from the measured first time duration to produce a value for the time delay, and thereafter removing as much oxygen as possible from the oxygen store or filling the oxygen store with as much oxygen as possible, changing over to an exposure of the oxygen store with lean or rich exhaust gas, respectively, terminating the exposure when the output signal of the lambda probe crosses a predetermined threshold, computing the time integral over the quantity of oxygen introduced into or removed from the oxygen store per unit time, and shifting the boundaries of the time integral commensurate with the measured time delay.

With this method, the time delay is measured precisely, allowing computation of the correct time integral with the greatest possible precision.

The computation of the time integral can begin at the time of the changeover, whereafter the time when the threshold is crossed is determined and the measured time delay is subtracted from the latter time, thereby correcting the temporal end of the computation of the integral. However, intermediate values may then need to be stored in a memory when computing the integral.

In a simplified approach, the time integral may start at a time which is shifted with respect to the time of the changeover by the measured time delay and the time integral ends at the time the threshold is reached. As long as the exposure to the exhaust gas does not change, meaning that neither the air-fuel ratio changes nor the exhaust gas mass flow changes, this preferred simpler embodiment produces exactly the same value for the time integral as the aforementioned method involving correction of the end of the integral.

According to another aspect of the present invention, a method for evaluating the oxygen storage capacity of an oxygen store associated with a catalytic converter in the exhaust gas system of an internal combustion engine, wherein a lambda probe is arranged downstream of at least one section of the catalytic converter in the flow direction of the exhaust gas, includes the steps of removing as much oxygen as possible from the oxygen store or filling the oxygen store with as much oxygen as possible, thereafter changing over to an exposure of the oxygen store with lean exhaust gas following removal of oxygen or to an exposure with rich exhaust gas following filling with oxygen, measuring a time delay between a time of the changeover and a time when the output signal of the lambda probe satisfies a predetermined criterion, computing a time integral over a quantity of oxygen introduced into or removed from the oxygen store per unit time or measuring a time elapsed during the changeover, and defining a limit value for the time integral or for the time by adding the time delay to a basic limit value.

If the time integral or the time exceeds the limit value before the output signal of the lambda probe has reached a predetermined threshold, the exposure during the changeover is terminated and it is concluded that the oxygen storage capacity is adequate.

Conversely, if the output signal of the lambda probe has reached a predetermined threshold and the time integral or the time has not yet exceeded the limit value, the exposure during the changeover is terminated and the following method steps are performed:

measuring a time delay inherent in the lambda probe by awaiting or effecting a beginning of an overrun mode of the internal combustion engine, measuring a first time duration from the beginning of the overrun mode to a time when an output signal of the lambda probe crosses a threshold value, defining a first estimated value for a second time duration from the start time until the oxygen store is filled with oxygen in overrun mode, defining a second estimated value for a third time duration from the start time until the exhaust gas reaches the lambda probe, and subtracting the first and second estimated values from the measured first time duration to produce a value for the time delay, and thereafter removing as much oxygen as possible from the oxygen store or filling the oxygen store with as much oxygen as possible, changing over to an exposure of the oxygen store with lean or rich exhaust gas, respectively, terminating the exposure when the output signal of the lambda probe crosses a predetermined threshold, computing the time integral over the quantity of oxygen introduced into or removed from the oxygen store per unit time, and shifting the boundaries of the time integral commensurate with the measured time delay.

Because the oxygen store may be continually exposed to exhaust gas until the oxygen store is completely filled (or emptied), a relatively large amount of harmful exhaust gas may be released into the environment during the measurement of the oxygen storage capacity. The aforedescribed method thus takes into account that the oxygen storage capacity itself need not always be measured very precisely, but that only a determination needs to be made if the oxygen storage capacity is still adequate. As long as the oxygen storage capacity is very high, only a differentiation between “high” and “very high” needs to be made. A coarse measurement is therefore sufficient.

The aforedescribed method is based on the concept that while the time delay between the time of the changeover and the time, when a predetermined criterion relating to the output signal of the lambda probe is satisfied, is only coarsely defined, it is sufficient to check also only coarsely if the oxygen storage capacity is sufficient. As soon as the oxygen storage capacity falls below a minimum value (meaning that the time integral does not exceed the limit value in due time, or that the time which is proportional to the time integral for constant air-fuel ratio and constant exhaust gas mass flow does not exceed the limit value in due time), then the oxygen storage capacity must be assumed to be too low, so that a numerical value must be determined to exactly determine if the oxygen storage capacity is adequate. This is done by measuring the time delay inherent in the lambda probe, which guarantees adequate precision for an aged oxygen store and an aged lambda probe.

in summary, an excellent test to check for sufficient oxygen storage capacity is feasible for both a new oxygen store and an aged oxygen store having a low oxygen storage capacity, regardless of whether or not the lambda probe has experienced aging and has an inherent time delay. The inherent time delay can be precisely measured by performing the method for determining the oxygen storage capacity, as soon as the oxygen store has experienced aging.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an arrangement which can be used to perform the method according to the invention;

FIG. 2A shows the probe voltage of a post-catalytic converter lambda probe when performing a coarse test for the oxygen storage capacity of an oxygen store, for both a fully functional post-catalytic converter lambda probe and an aged post-catalytic converter lambda probe exhibiting a time delay; and

FIG. 2B shows the oxygen storage capacity corresponding to the curves of FIG. 2A;

FIG. 3A shows how the oxygen store of an internal combustion engine having a high oxygen storage capacity is slowly filled in overrun mode, and the shape of output signals from a fully functional and an aged post-catalytic converter lambda probe;

FIG. 3B shows a similar set of curves as in FIG. 3A, however for an oxygen store having a reduced oxygen storage capacity compared to its original oxygen storage capacity, and

FIG. 4 shows a curve depicting the decrease in the oxygen storage capacity over time and indicating which type of method needs to be performed at which time.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In predetermined instances, details which are not necessary for an understanding of the present invention or which render other details difficult to perceive may have been omitted.

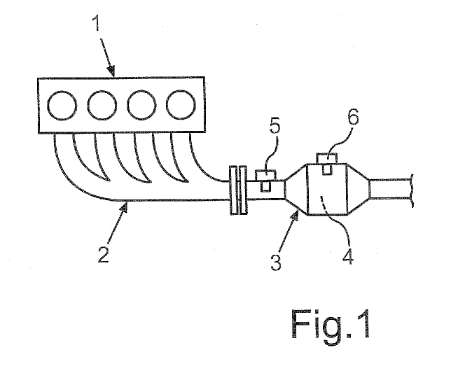

Turning now to the drawing, and in particular to FIG. 1, there is shown a schematic diagram of an internal combustion engine with an exhaust gas system 2. The exhaust gas system 2 includes an exhaust gas catalytic converter 3, configured for example as a 3-way catalytic converter, as an NOX storage catalytic converter or as an active particle filter, as well as an integrated oxygen store. The exhaust gas system 2 further includes a pre-catalytic converter lambda probe 5 arranged upstream of the exhaust gas catalytic converter 3, operating as a master probe, and a post-catalytic converter probe 6 associated with the exhaust gas catalytic converter 3 and operating as a control probe.

In the depicted exemplary embodiment, the post-catalytic converter lambda probe 6 is arranged downstream of the exhaust gas catalytic converter 3; however, the post-catalytic converter lambda probe could also be arranged directly inside the exhaust gas catalytic converter 3, i.e., after a partial volume or a partial section of the oxygen store 4.

It will be assumed hereinafter that the exhaust gas of the internal combustion engine 1 can be adjusted at least with a predetermined accuracy to a predetermined air-fuel ratio lambda.

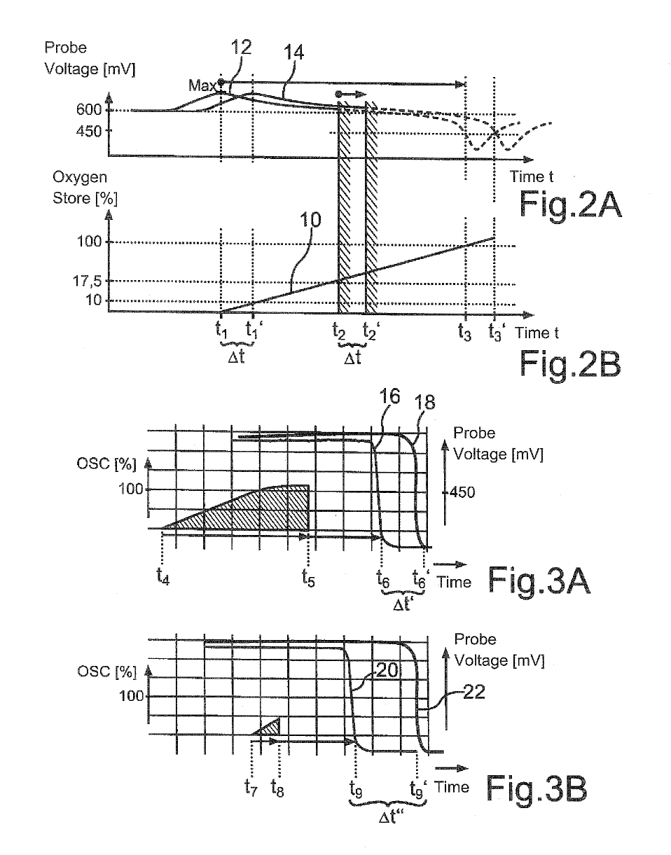

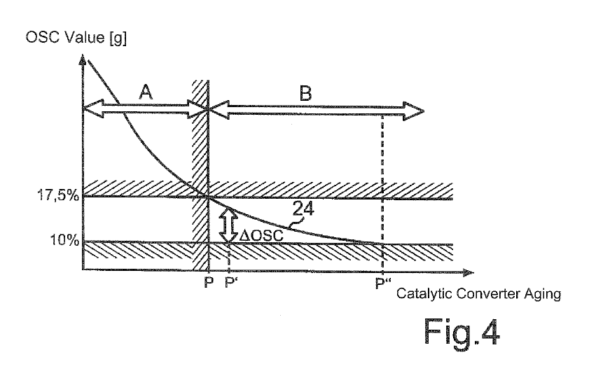

It will now be described with reference to FIGS. 2A and 2B, how an oxygen store with still relatively high oxygen storage capacity can be tested to determine if the oxygen storage capacity is adequate.

For example, the test should ensure that at least 10% of the nominal oxygen storage capacity, i.e., the original oxygen storage capacity, is still available.

For this purpose, the catalytic converter 3 and the oxygen store 4 are initially exposed to rich exhaust gas until the oxygen store is emptied. Thereafter, at a time t₁, lean exhaust gas is introduced. As seen from curve 10, the oxygen store is then successively filled with oxygen, linear with the time t. The relationship is linear as long as the air-fuel ratio and the exhaust gas mass flow remain constant.

At the time t₁, the output signal of a fully functional post-catalytic converter lambda probe 6 shows a maximum. A post-catalytic converter lambda probe can be considered to be fully functional if the maximum coincides with the time t₁. For coarsely determining an adequate oxygen storage capacity, a basic limit value is hereby defined, which is 1.75 times greater than the actual limit value: this basic limit value would be reached at a time t₂. A value for the stored oxygen storage quantity OSC can be determined with the following formula:

$$O S C = 0 , 23 {\int }_{ta}^{tb} ( λ ( t ) - 1 ) \dot{m} ( t ) d t , \qquad ( 1 )$$

wherein λ(t) is the area-fuel ratio applied to the oxygen store, and \dot{m}(t) is the exhaust gas mass flow. In the present example, where λ=constant, \dot{m}=constant, a value for the time may also be selected as the basic limit value. Curve 14 shows that all signal values for an aged lambda probe occur with a delay. The maximum is therefore reached at a time t₁′, and the time t₁′−t₁ corresponds exactly to the delay Δt exhibited by the post-catalytic converter lambda probe 6. This delay is hereby taken into account by also commensurately shifting the limit value, in the present example from t₂ to t₂′, with=Δt. (The limit value can be similarly changed for the integrals according to the above computation).

FIGS. 2A and 2B show that the times t₂ and t₂′ can both be reached before the probe voltage of the post-catalytic converter lambda probe crosses the value of 0.45 V. This value is crossed when the oxygen store is completely filled during exposure to lean exhaust gas. The threshold value is crossed in FIG. 2A/2B at a time t₃, for an aged post-catalytic converter lambda probe at a time t₃′.

The smaller the oxygen storage capacity, the closer is t₃ to t₂, and t₃′ to t₂°. Coarsely setting the limit values for a very low oxygen storage capacity has the effect that these limit values are no longer reached before the output voltage of the post-catalytic converter lambda probe crosses the value of 0.45 V. The test then no longer yields a positive result. However, this does not indicate that the oxygen storage capacity has fallen below the value of 10%. Instead, a more sophisticated measurement of the oxygen storage capacity is necessary.

The more sophisticated measurement shows that the measurement of the time delay Δt with the method described with reference to FIGS. 2A and 2B is not sufficiently accurate. Instead, the time delay in the reaction of the aged post-catalytic converter lambda probe is measured using the following approach:

A transition of the internal combustion engine into the overrun mode, i.e., when for example a driver steps off the gas and lets the vehicle coast, is first awaited. If the overrun mode starts at a time t₄, then the oxygen store is filled to 100% at a time t₅. Before a reaction in the post-catalytic converter lambda probe can occur, the exhaust gas must still pass through the catalytic converter 3 and the oxygen store 4. Starting from the time t₅, this occurs at a time t₆. According to the curve 16, a fully functional post-catalytic converter lambda probe operating shows indeed a jump at the time t₆, crossing the value of 0.45 V. An aged lambda probe of the post-catalytic converter lambda probe 6 reacts according to the curve 18, the jump occurs only at a time t₆′ which is delayed by Δt′ with respect to t₆. Δt′ is the delay that can be precisely measured.

If the oxygen storage capacity of the oxygen store is approximately known, then the time from t₄ to t₅ can be estimated, while the time from t₅ to t₆ is essentially known anyway. Δt′ can then be measured.

This approach is hereby only used with aged catalytic converters: the limit of the oxygen storage capacity is reached, starting from a time t₇, already almost immediately thereafter at a time t₈. The exhaust gas then passes through the catalytic converter 3 and the oxygen store until a time t₉, wherein t₉−t₈=t₆−t₅.

A fully functional post-catalytic converter probe then reacts according to the curve 20, an aged post-catalytic converter probe 6 according to the curve 22. By measuring the time shift between t₉′ and t₇ and with the assumption t₈−t₇=0, the time delay Δt″ can be determined as t₉′−t₇−(t₉−t₈)=t₉′−t₇−(t₆−t₅), wherein t₆−t₅ is precisely known from assumptions. Δt″ can then be calculated with an error that corresponds exactly to the time between t₈ and t₇. This error is relatively small.

After the time Δt″ has been measured, the above formula for OSC can now be used to precisely determine the oxygen storage capacity. Instead of terminating exposure to lean exhaust gas at the time t₂ or t₂′, as described above with reference to FIGS. 2A and 2B, the integral is hereby precisely computed, wherein tₐ is the time t₁ of the changeover to exposure with lean exhaust gas, and t_{b} is the time t₃ or t₃′ when the output signal of the post-catalytic converter probe drops below a threshold value. If the time delay Δt″ is known, then the boundaries tₐ and t_{b} of the integral can be suitably shifted, e.g., by starting the computation of the integral no sooner than at the time tₐ+Δt″.

If the oxygen storage capacity follows the curve 24 and if the limit value is around 10% and a coarse limit value is around 17.5%, then the initially described method for coarse testing is performed until the (virtual) time P related to the aging of the catalytic converter is reached, i.e. the upper threshold value of 17.5% in relation to the original oxygen storage capacity has been reached. This coarse test represents the method A. As soon as the value drops below the point P, the method B is performed, which has been described above with reference to FIGS. 3A and 3B and also with reference to FIG. 2A. With the method B, the oxygen storage capacity is precisely measured according to curve 24, and a difference ΔOSC shown in the Figure can be determined for the time P. As long as this difference still has a finite value, the test still shows that the oxygen storage capacity is adequate. The oxygen storage capacity falls below the absolute lower limit at the time P″.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for determining a time delay in the reaction of a lambda probe to changes in the air-fuel ratio to be measured, wherein the lambda probe is arranged in the exhaust gas system of an internal combustion engine downstream of at least a section of a catalytic converter having an oxygen store, comprising the steps of:
awaiting or effecting a beginning of an overrun mode of the internal combustion engine,
measuring a first time duration from the beginning of the overrun mode to a time when an output signal of the lambda probe crosses a threshold value,
defining a first estimated value for a second time duration from the start time until the oxygen store is filled with oxygen in overrun mode,
defining a second estimated value for a third time duration from the start time until the exhaust gas reaches the lambda probe, and
subtracting the first and second estimated values from the measured first time duration to produce a value for the time delay.

2. The method of claim 1, wherein the catalytic converter has been subjected to an aging process and has only between a twentieth and a fifth of an original oxygen storage capacity.

3. The method of claim 2, wherein the first estimated value is set to zero.

4. A method for determining the oxygen storage capacity of an oxygen store associated with a catalytic converter in the exhaust gas system of an internal combustion engine, wherein a lambda probe is arranged downstream of at least a section of the catalytic converter in the flow direction of the exhaust gas, includes the steps of:
measuring a time delay in a reaction of a lambda probe to changes in the air-fuel ratio by:
awaiting or effecting a beginning of an overrun mode of the internal combustion engine,
measuring a first time duration from the beginning of the overrun mode to a time when an output signal of the lambda probe crosses a threshold value,
defining a first estimated value for a second time duration from the start time until the oxygen store is filled with oxygen in overrun mode,
defining a second estimated value for a third time duration from the start time until the exhaust gas reaches the lambda probe, and
subtracting the first and second estimated values from the measured first time duration to produce a value for the time delay, thereafter
removing as much oxygen as possible from the oxygen store or filling the oxygen store with as much oxygen as possible,
changing over to an exposure of the oxygen store with lean or rich exhaust gas, respectively,
terminating the exposure when the output signal of the lambda probe crosses a predetermined threshold,
computing the time integral over the quantity of oxygen introduced into or removed from the oxygen store per unit time by shifting the boundaries of the time integral commensurate with the measured time delay, and
computing the oxygen storage capacity from the time integral.

5. The method of claim 4, wherein shifting the boundaries of the time integral comprises delaying a start of the time integral with respect to a time of the changeover by the value for the time delay, and terminating the time integral at a time the predetermined threshold is crossed.

6. A method for evaluating the oxygen storage capacity of an oxygen store associated with a catalytic converter in the exhaust gas system of an internal combustion engine, wherein a lambda probe is arranged downstream of at least one section of the catalytic converter in the flow direction of the exhaust gas, comprising the steps of:
removing as much oxygen as possible from the oxygen store or filling the oxygen store with as much oxygen as possible, thereafter
changing over to an exposure of the oxygen store with lean exhaust gas following removal of oxygen or to an exposure with rich exhaust gas following filling with oxygen,
measuring a time delay between a time of the changeover and a time when the output signal of the lambda probe satisfies a predetermined criterion, wherein
computing a time integral over a quantity of oxygen introduced into or removed from the oxygen store per unit time or measuring a time elapsed during the changeover, wherein
defining a limit value for the time integral or for the time by adding the time delay to a basic limit value,
if the time integral or the time exceeds the limit value before the output signal of the lambda probe has reached a predetermined threshold, terminating the exposure during the changeover and concluding that the oxygen storage capacity is adequate,
if the output signal of the lambda probe has reached a predetermined threshold and the time integral or the time has not yet exceeded the limit value, terminating the exposure during the changeover and performing the following method steps:
measuring a time delay inherent in the lambda probe by
awaiting or effecting a beginning of an overrun mode of the internal combustion engine,
measuring a first time duration from the beginning of the overrun mode to a time when an output signal of the lambda probe crosses a threshold value,
defining a first estimated value for a second time duration from the start time until the oxygen store is filled with oxygen in overrun mode,
defining a second estimated value for a third time duration from the start time until the exhaust gas reaches the lambda probe, and
subtracting the first and second estimated values from the measured first time duration to produce a value for the time delay,
removing as much oxygen as possible from the oxygen store or filling the oxygen store with as much oxygen as possible, changing over to an exposure of the oxygen store with lean or rich exhaust gas, respectively,
terminating the exposure when the output signal of the lambda probe crosses a predetermined threshold,
computing the time integral over the quantity of oxygen introduced into or removed from the oxygen store per unit time by shifting the boundaries of the time integral commensurate with the measured time delay, and
computing the oxygen storage capacity from the time integral.

7. The method according to claim 6, wherein if the output signal of the lambda probe has reached a predetermined threshold and the time integral or the time has not yet exceeded, method steps that have previously been performed will not be repeated.
